(19) United States
(12) Patent Application Publication
(10) Pub. No.: US 2006/0256512 A1
(43) Pub. Date: Nov. 16, 2006

(54) Display panel mount for a notebook or tablet computer

(76) Inventor: Mi Jung Esther Kang, Knoxville, TN (US)

Correspondence Address: MICHAEL E. McKEE;Attorney at Law, 804 Swaps Lane, Knoxville, TN, 37923, US

(21) Appl. No.: 11/126,899

(22) Filed: May 11, 2005

(51) Int. Cl. G06F 1/16

(52) U.S. Cl. 361/681

(57) ABSTRACT

A portable notebook or tablet computer having a relatively thin computer body and a relatively thin display panel includes at least one elongated arm member which is pivotally attached at one end to the computer body to permit pivotal movement of the arm member relative to the computer body and is pivotally attached at the other end to the display panel to permit pivotal movement of the display panel relative to the arm member. By pivotally moving the arm member relative to the computer body and pivotally moving the display panel relative to the arm member, the display panel can be oriented in any of a number of positions relative to the Computer body to increase the likelihood that the display panel can be positioned in a position for optimum viewing by the user.

### FIELD OF THE INVENTION

The present invention relates to notebook and tablet computers and relates, more particularly, to the means by which a display panel is attached to the body of such a computer.

### BACKGROUND OF THE INVENTION

Each of the notebook and tablet computers with which this invention is to be compared includes a relatively flat computer body, or base unit, and a relatively flat display panel having a screen which is hingedly connected to the computer body for movement between closed and opened conditions. Such computers are currently quite popular and are widely used due, in part, to the slimness, the lightness in weight and the portability of the computers.

When a computer of the aforedescribed class is situated upon a horizontal surface, the display panel can be typically pivoted about a horizontal axis between an open condition at which the display panel is disposed in a near-vertical condition adjacent the back of the computer body and a closed condition at which the display panel is positioned in overlying relationship with the computer body. Because the display panel is situated adjacent the back of the computer when in its opened condition, the user is provided with access to the keys of a keyboard normally carried atop the computer body, but depending upon the location of the user's eyes in relation to the display panel when the computer is being used, the screen of the display panel may be difficult for the user to see, or in other words, the screen of the display panel might not be capable of being oriented relative to the user at an optimum viewing angle.

If, for example, the computer body is supported within the lap of a user and the display panel is opened to a near-vertical condition, the screen of the display panel may still be difficult to see because the screen cannot be tilted rearwardly far enough to enable the screen to face, or be directed toward, the user's eyes. Furthermore, the difficulty of viewing the display panel is increased when the computer is attempted to be used in a relatively tight space, such as within the passenger seat of an airplane or upon a crowded office desk, or in a place with relatively poor lighting.

It would be desirable to provide a notebook or tablet computer having a display panel which can be moved between any of a number of alternative orientations relative to the computer body so that the screen of the display panel can be easily viewed by the user.

Accordingly, it is an object of the present invention to provide a new and improved notebook or tablet computer having a display panel which is hingedly connected to the computer body and whose display panel can be oriented in any of a number of orientations relative to the computer body to enhance the viewability of the screen of the display panel by a user.

Another object of the present invention is to provide such a computer with a means for joining the display panel to the computer body so that the display panel can be readily moved between an opened condition for use of the computer and a closed condition.

A still further object of the present invention is to provide such a computer whose means for joining the display panel to the computer body is uncomplicated in structure, yet effective in operation.

### SUMMARY OF THE INVENTION

This invention resides in an improvement in a notebook or tablet computer having a relatively thin computer body and a relatively thin display panel.

The improvement includes an arm member having two opposite ends wherein one end of the arm member is attached to the computer body to permit pivotal movement of the arm member relative to the computer body and wherein the other end of the arm member is attached to the display panel to permit pivotal movement of the display panel relative to the arm member. By pivotally moving the arm member relative to the computer body and pivotally moving the display panel relative to the arm member, the display panel can be oriented in any of a number of positions relative to the computer body.

In one aspect of the present invention, a pair of extension arms are positioned on opposite sides of the computer body and are each pivotally attached to the sidewalls of the computer body housing adjacent the middle thereof and are each pivotally connected to the lower edge, or rim, of the screen of the display panel so that the display panel can be pivoted forwardly or rearwardly for adjusting the height and position of the screen relative to the computer body. When the lower edge of the display panel is subsequently pulled toward the user, the screen of the display panel can be made to face upwardly so that the computer can be used as the tablet computer. When the lower edge of the display panel is thereafter pushed away from the user to close the computer, the screen faces downwardly over the computer body.

In another aspect of the present invention, a pair of extension arms are each pivotally attached to the housing of the computer body adjacent the forward area thereof and are each pivotally attached to the display panel adjacent the lower rim thereof so that the display panel can be pivoted upwardly or downwardly relative to the computer body for adjusting the height and position of the display panel relative to the computer body housing. When subsequently collapsed upon the computer body to close the computer, the screen of the display panel faces downwardly.

In still another aspect of the present invention, a pair of extension arms are pivotally attached to the sidewalls of the computer body housing adjacent the rearward area thereof and are pivotally attached to the display panel adjacent the lower rim thereof so that the display panel can be pivoted upwardly or downwardly for adjusting the height and position thereof relative to the computer body. If collapsed from a raised position, the screen of the display panel can be made to face upwardly so that the computer can be used as a tablet computer. If desired, a protective bag or pouch which is lined with a thin plastic or metal plate can be provided for carrying and protecting the computer.

In yet another aspect of the present invention, a singular extension arm is pivotally attached to a sidewall of a notebook computer body and is pivotally attached to the display panel adjacent the lower rim thereof so that the display panel can be pivoted forwardly or rearwardly for adjusting the height and position of the display panel relative to the computer body. When the display panel is oriented in a near-vertical opened condition and the lower edge of the display panel is subsequently pulled toward the user, the screen of the display panel can be made to face upwardly so that the computer can be used as a tablet computer. In the alternative, when the display panel is oriented in a near-vertical position and the lower edge of the display panel is pushed away from the user, the screen of the display panel can be made to face downwardly so as to close the computer.

In another aspect of the present invention, a notebook computer is coupled to its display panel with one extension arm which is pivotably coupled to the forward area on a sidewall of the computer body housing and is also pivotably coupled to the lower rim of the display panel so that the height and position of the display panel relative to the computer body can be adjusted as desired.

In a further aspect of the present invention, the body of the computer is coupled to the display panel with one extension arm which is pivotally attached to the computer body adjacent the rearward area thereof and is pivotally coupled to the display panel adjacent the lower rim thereof so that the height and position of the display panel relative to the computer body can be adjusted as desired. If collapsed from a near-vertical position by pulling the lower rim toward the user, the screen of the display panel can be made to face upwardly so that the computer can be used as a tablet computer.

In a still further embodiment of the present invention, the display panel and the computer body housing are connected to one another with an extension arm that is hingedly coupled to the housing of the computer body adjacent the rear thereof and is hingedly coupled to the back of the display panel through a sliding plate that is held in rails or grooves with a set screw, latch or friction-fit arrangement. The computer can be opened as is a conventional notebook computer, but can be further adjusted by altering the position of the sliding plate relative to the extension arm. In other words, the movability of the sliding plate relative to the extension arm enables the height and position of the display panel to be adjusted relative to the computer body housing as the display panel is shifted along the length of the extension arm. With the aid of the set screw, latch or friction-fit arrangement, the sliding plate can be positioned and held in a fixed position along the length of the extension arm. If the display panel is positioned in its near-vertical position, the display panel can thereafter be manipulated to close the computer or opened to provide a tablet computer.

If desired, a protective bag having a thin plastic or metal plate which is embedded within at least one side of the bag can be utilized for carrying and protecting the computer while its display panel is positioned so as to face away from the computer body.

### BRIEF DESCRIPTION OF THE DRAWINGS

FIG. 1A is a perspective view of a notebook/tablet computer incorporating a pair of extension arms for pivotally coupling the computer body to the display panel.

FIG. 1B is the front view of the FIG. 1A embodiment.

FIG. 1C is a side view of the FIG. 1A embodiment.

FIG. 1D is a side view of the FIG. 1A embodiment similar to that of FIG. 1C, but illustrating its display panel arranged screen-side-down in a collapsed, or closed, condition.

FIG. 1E is a side view of the FIG. 1A embodiment similar to that of FIG. 1C, but illustrating its display panel arranged screen-side-up for upwardly for use of the computer as a tablet computer.

FIG. 2A is a perspective view of another embodiment of the present invention in the form of a laptop computer which incorporates a pair of extension arms for pivotally coupling the body of the computer to its display panel.

FIG. 2B is a perspective view of another variation of the embodiment of a notebook/tablet computer incorporating a pair of extension arms for pivotally coupling the body of the computer to the display panel according to the invention.

FIG. 2C is the front view of the embodiment of FIG. 2B.

FIG. 3A is a perspective view of another embodiment of a notebook/tablet computer which incorporates a single extension arm for pivotally coupling the body of the computer to the display panel thereof.

FIG. 3B is a front view of the embodiment shown in FIG. 3A.

FIG. 3C is a perspective view of still another embodiment of a notebook/tablet computer which incorporates a single extension arm for pivotally coupling the body of the computer to the display panel thereof.

FIG. 3D is a perspective view of yet another embodiment of a notebook/tablet computer which incorporates a single extension arm for pivotally coupling the body of the computer to the display panel thereof.

FIG. 4A is a perspective view of a further embodiment of a notebook/tablet computer which incorporates a single extension arm for hingedly coupling the body of the computer to the display panel thereof.

FIG. 4B is a rear view of the embodiment shown in FIG. 4A.

FIG. 4C is a side view of the embodiment of FIG. 4B.

FIG. 4D is a side view of the FIG. 4B embodiment similar to that of FIG. 4C but illustrating the display panel of the computer in an alternative angular position to that illustrated in FIG. 4C.

FIG. 4E is a side view of the FIG. 4B embodiment similar to that of FIG. 4C but illustrating the display panel of the computer screen-side-down in a closed condition.

FIG. 4F is a side view of the FIG. 4B embodiment similar to that of FIG. 4B but illustrating the display panel of the computer screen-side-up for use as the computer as a tablet computer.

FIG. 5A is a perspective view of an embodiment of a protective bag that can be used with a tablet computer whose display screen is exposed.

FIG. 5B is a perspective view of a variation of the embodiment shown in FIG. 5A having an alternative arrangement for locking the bag in a closed condition and having a handle.

FIG. 5C is a perspective view of another variation of the embodiment shown in FIG. 5A having another arrangement for locking the embodiment in a closed condition.

### DETAILED DESCRIPTION OF THE ILLUSTRATED EMBODIMENTS

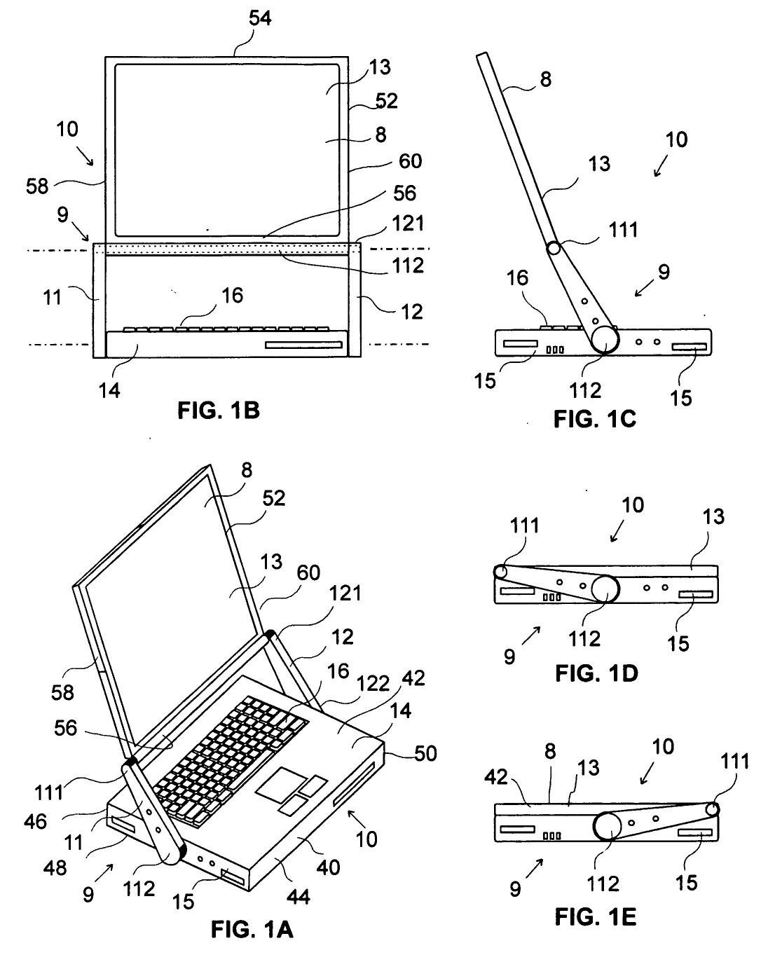

Turning now to the drawings in greater detail and considering first FIG. 1A-1E, there is illustrated an embodiment, generally indicated 10, of a notebook computer within which features of the present invention are embodied. More specifically, the computer 10 includes a relatively thin base unit, or body 14, and an associated display panel 13 having a relatively flat, rectangular display, or screen 8, and further includes means, generally indicated 9, for hingedly connecting the computer body 14 to the display panel 13 to enable the display panel 13 to be positioned in any of a number of angular orientations relative to the computer body 14 and thereby improve the chances that the screen 8 of the display panel 13 can be positioned for optimum viewing by the eyes of the user. For present purposes, the display panel 13 is positioned for optimum viewing if the line of sight between the user's eyes and the display panel 13 forms substantially a right angle with the screen 8 of the display panel 13.

The body 14 of the depicted computer 10 includes a keyboard 16 and accessory ports 15 whose function and operation are well-known in the art so that a more detailed description of them is not believed to be necessary. Furthermore, the body 14 includes an outer housing 40 having an upper surface 42 within which the keys of the keyboard 16 are supported, a front edge 44 which is directed toward the user when the computer 10 is being used, a back edge 46, and two opposite sidewalls 48, 50.

Furthermore, the display panel 13 includes border sections 52 which border the screen 8 of the panel 13. As best shown in FIG. 1B, the border sections 52 include a top rim 54 which extends along the upper edge of the display panel 13, a bottom rim 56 which extends along the lower edge of the display panel 13 and two opposite side rims 58, 60 which extend along the opposite side edges of the panel 13.

In the depicted computer 10, the connecting means 9 includes a pair of arm members, or extension arms 11, 12, which are each pivotally connected at one end 112 or 122 to a corresponding sidewall 48 or 50 of the computer body housing 44 and are each pivotally connected at the opposite end 111 or 121 to a corresponding side rim 58 or 60 of the display panel 13. The pivot axes about which each set of extension arm ends 112 and 122 or 111 and 121 are permitted to pivot are substantially parallel to one another.

As best shown in FIG. 1C, the lower ends 112, 122 (as viewed in FIGS. 1A-1C) of the extension arms 11, 12 are pivotally coupled to the computer body housing 44 at about the middle of the sidewalls 48, 50. Meanwhile, the opposite, or upper, ends 111, 121 of the extension arms 11, 12 are pivotally coupled to the side rims 58, 56 of the display panel 13 adjacent the lower rim 56 thereof. With the arms 11, 12 connected between the computer body housing 44 and the display panel 13 in this manner, both the display panel 13 and the upper ends 111, 121 of the extension arms 11, 12 are permitted to pivot forwardly or rearwardly relative to the computer body 14 in a manner which permits the user to move the display panel 13 to any of a number of positions or heights relative to the computer body 14, and such a capacity increases the likelihood that the display panel 13 can be positioned at an optimum angle for viewing, even if the computer 10 is used in tight, or close, quarters.

To enhance the stability of the display panel 13 when supported in an elevated condition above the computer body 14 by the extension arms 11, 12, a rod 112 (FIG. 1A) can be positioned within the display panel 13 adjacent the lower rim 56 thereof and fastened to the upper ends 111, 121 of the extension arms 11, 12. Such an arrangement reduces any likelihood that the display panel 13 will shift relative to the body 14 in a manner which shifts the upper end 111 or 121 of one of the extension arms 11, 12 forwardly or rearwardly without a corresponding movement of the upper end 121 or 111 of the other extension arm 11, 12. Therefore, the pin 112 helps to rigidify the display panel 13 when supported in an elevated condition above the body 14 by the extension arms 11, 12 and is advantageous in this respect.

Furthermore, the aforedescribed connection between the computer body 14 and the extension arms 11, 12 and between the extension arms 11, 12 and the display panel 13 enables the computer 10 to be utilized as a conventional notebook computer 10 wherein the display panel 13 can be oriented at about a right angle relative to the computer body 14 or, in other words, to a near-vertical condition, as illustrated in FIGS. 1A-1C, and wherein a user has access to the keys of the keyboard 16 mounted upon the computer body 14. Further still, the aforedescribed interconnection between the computer body 14, extension arms 11, 12 and display panel 13 also enables the computer 10 to be utilized as a tablet computer, as illustrated in FIG. 1E, wherein the display panel 13 is positionable atop the computer body 14 so that the screen 8 of the display panel 13 faces generally away from the upper surface 42 (or keyboard-supporting surface) of the computer body 13 to expose the screen 8 so that it can be worked upon by the user.

When the display panel 13 is positioned in its opened condition as illustrated in FIGS. 1C, the display panel 13 can be moved to a closed condition, as illustrated in FIG. 1D, by pushing the lower rim 56 of the display panel 13 rearwardly of the computer body 14 while simultaneously pulling the upper rim 54 of the display panel 13 forwardly and then downwardly upon the upper surface 42 of the computer body 14. Each of the display panel 13 and the extension arms 11 and 12 can be made to resist movement by sizing the joined components in a close, or friction-fit, relationship so that a user must apply a force against the extension arms 11 and 12 or the display panel 14 in order to move the components from a stationary condition. This way, the display panel 13 can be manually moved to a desired position and remain in that position when the user releases the display panel 13. In the alternative, the display panel 13 can be releasably maintained in a fixed position relative to the computer body 40 by means of an appropriately positioned set screw or latch.

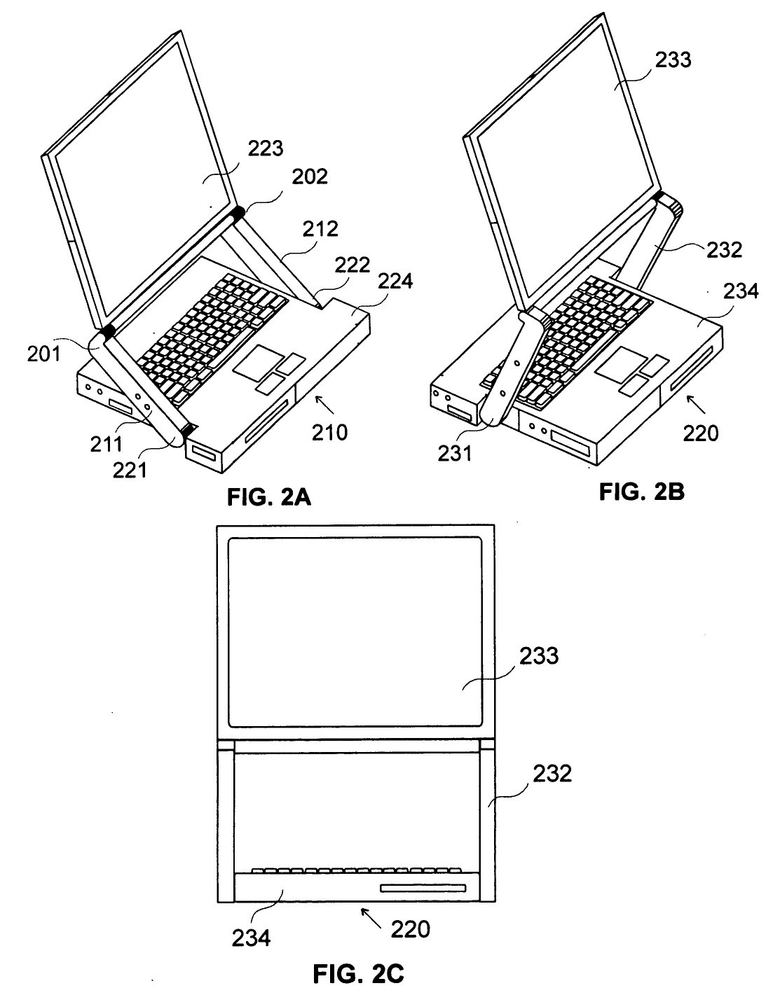

With reference to FIGS. 2A, there is illustrated another embodiment 210 of the present invention having a computer body 224 and a display panel 223. In the embodiment of FIG. 2A, a pair of extension arms 211, 212 are pivotally attached at the lower ends 221, 222 to the computer body 224 and are pivotally attached at the upper ends 201, 202 thereof to the display panel 229. As is the case with the embodiment 10 of FIGS. 1A-1E, the extension arms 211 and 212 of the embodiment 210 permit the display panel 223 to be pivoted relative to the computer body 224 about two parallel (and horizontally-disposed) axes of pivot, one axis of which extends through the ends 211 and 212 of the extension arms 211 and 212, and the other axis of which extends through the ends 201 and 202 of the extension arms 211 and 212.

With reference to FIGS. 2B and 2C, there is illustrated yet another embodiment 220 of a computer having a body 234 and a display panel 233 and within which features of the present invention are embodied. Within the embodiment of FIGS. 2B and 2C, the lower ends (as viewed in FIGS. 2B and 2C) of the extension arms 231, 232 are pivotally coupled to the lower rim 239 of the display 233 of the computer body 230. Coupled in this manner, both the display 233 and the extension arms 231, 232 are permitted to pivot upwardly for adjusting the height and position of the display relative to the computer body housing 234.

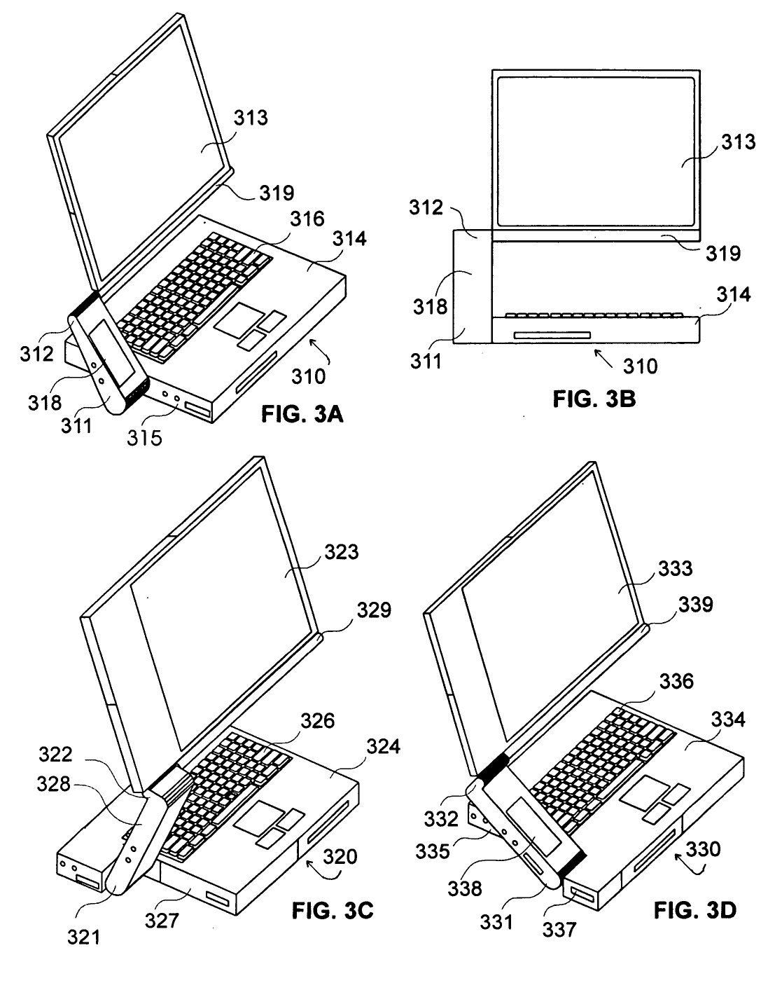

With reference to FIGS. 3A and 3B, there is illustrated a further embodiment 310 of a computer having a computer body housing 314 and a display panel 313 and within which features of the present invention are embodied. The computer body housing 314 is provided with a keyboard 316 and is pivotally connected to the display panel 313 with a single extension arm 318. The lower end 311 of the extension arm 318 is pivotally coupled to one sidewall 315 of the housing 314 at about the middle thereof. The other, or upper, end 312 of the extension arm 318 is pivotally coupled to the lower rim 319 of the display 313 of the computer 310. Connected in this manner, both the display panel 313 and the extension arm 318 are adapted to be pivoted forwardly or rearwardly relative to the housing 324 for adjusting the height and position of the display panel 313 relative to the housing 314. Furthermore, this configuration enables the computer 320 to be used as either a conventional notebook computer of a tablet personal computer (PC). In this regard, the display panel 313 can be moved from a near-vertical condition to a screen-down condition by pushing the lower edge of the display panel 313 rearwardly of the computer housing 324. The display panel 313 can be moved upwardly from a closed condition by pulling the lower edge of the display forwardly of the computer 310.

Inasmuch as the single extension arm 318 of the FIG. 3A embodiment 310 is illustrated as being relatively broad (i.e. has substantial thickness as viewed from the front of the embodiment 310), the arm 318 could be used to house selected accessories (not shown) for use with the embodiment 310.

In FIG. 3C, there is illustrated a still further embodiment, indicated 320, of a notebook computer embodying features of the present invention. The computer 320 includes a computer body having a housing 324 and a keyboard 326 which are pivotally connected to the display panel 323 of the computer 310 by means of a single extension arm 328. One end 321 of the extension arm 328 is pivotally coupled to one sidewall 327 of the housing 324 adjacent the rear thereof. The other end 322 of the extension arm 328 is pivotally coupled to the lower rim 329 of the display 323. With the extension arm 328 connected between the computer body housing 324 and the display panel 323 in this manner, each of the display panel 323 and the extension arm 328 are adapted to pivot about a pair of parallel and substantially horizontally-oriented axes so that the movement of the panel 323 and arm 328 can be altered to adjust the height and position of the display panel 323 relative to the housing 324.

With reference to FIG. 3D, there is illustrated a yet further embodiment, generally indicated 330, of a notebook computer embodying features of the present invention. Within the computer 330, there is provided a computer housing 334 within which a keyboard 336 is supported and which is pivotally connected to the computer display panel 333 by means of a single extension arm 338. To this end, one end 331 of 10 the extension arm 338 is pivotally coupled to one sidewall 335 of the housing 334 adjacent the front thereof, and the other end 332 of the extension arm 338 is pivotally coupled to the lower rim 339 of the display panel 333. Connected between the housing 334 and display panel 333 in this manner, the extension arm 338 permits the display panel 333 to be pivoted relative to the housing 334 about two parallel and substantially-horizontal axes of pivot (corresponding to the locations at which the opposite ends of the extension arm 331 are connected to the computer housing 334) to enable the display panel 333 to be shifted upwardly or downwardly for adjusting the height and position of the display panel 333 relative to the housing 334.

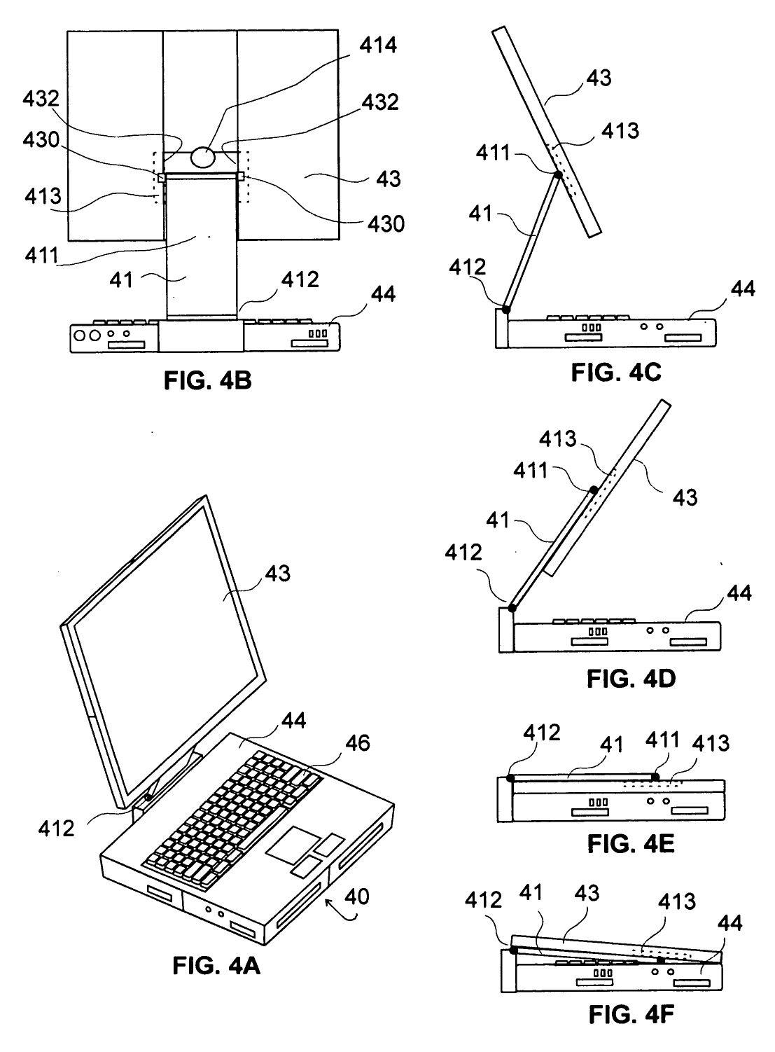

With reference to FIGS. 4A-4F, there is illustrated one more embodiment, generally indicated 40, of a notebook computer within which features of the present invention are embodied. The computer 40 includes a housing 44, a keyboard 46, a display panel 43, and a single extension arm 41 which is pivotally connected at its opposite ends to the housing 44 and display panel 43. More specifically, one end 412 of the extension arm 41 is hingedly connected to the housing 44 along the back thereof, and the other end 411 (i.e. the upper end as illustrated in FIG. 4B) of the extension arm 41 is slidably and pivotally connected to the display panel 43 along the back thereof.

In order to couple the extension arm 41 to the display panel 43 in the aforestated manner, there is provided a substantially rectangular sliding plate 413 which is fixedly secured to the back of the display panel 43 (on the side thereof opposite the screen thereof) and which defines opposing guide tracks 432 (FIG. 4B) along the opposite sides of the plate 413 and which, in turn, slidably accept protrusions 430 (FIG. 4B) directed outwardly from the opposite sides of the extension arm 41 at the upper end 411 thereof to permit the display panel 43 to be slidably moved (e.g. upwardly and downwardly, as viewed in FIG. 4B) relative to the computer body housing 40 as the guide tracks of the panel 43 are slidably moved along the protrusions 430. It follows that the plate 413 and the upper end of the extension arm 41 cooperate as guide track and guide track follower as the display panel 43 is slidably moved along the length of the extension arm 41 toward and away from the extension arm end 412.

To releasably secure the display panel 43 at a selected location along the extension arm 41, there is provided a set screw 414 having a knob at the head thereof and which is threadably accepted by an appropriately-threaded opening defined within the extension arm 41 adjacent the upper end 411 thereof so that by tightening the set screw 414 within this extension arm opening, the shank of the set screw is urged against the back surface of the display panel 43 so that the display panel 43 is secured in a fixed position along the length of the extension arm 41. By loosening the set screw 414, its shank moves out of engagement with the panel 43 so that the display panel 43 can thereafter by slidably moved along the length of the extension arm 41. It follows that the position of the display panel 43 relative to the computer body housing 44 can be altered by loosening the set screw 414, then moving the display panel 43 to an alternative location along the length of the extension arm 41, and subsequently re-tightening the set screw 414 to releasably secure the display panel 43 at the alternative location.

The computer embodiment 40 of FIGS. 4A-4F is opened from the illustrated FIG. 4F closed condition like that of a conventional notebook computer by lifting the display panel 43 relative to the computer housing 44 so that the display panel 43 pivots about the pivot axis extending through the lower end 412 of the extension arm 41. Moreover, the height of the display panel 43 relative to the computer housing 44 can be thereafter be adjusted by loosening the set screw 414 and slidably moving the display panel 43 along the length of the extension arm 41 to an alternative position therealong as described above. The set screw 414 is thereafter re-tightened to secure the display panel 43 along the length of the extension arm 41, and then the display panel 43 is pivoted, as necessary, about the pivot axis which extends through the upper end 411 of the extension arm 41 so that the screen of the display panel 43 can be easily viewed by the user.

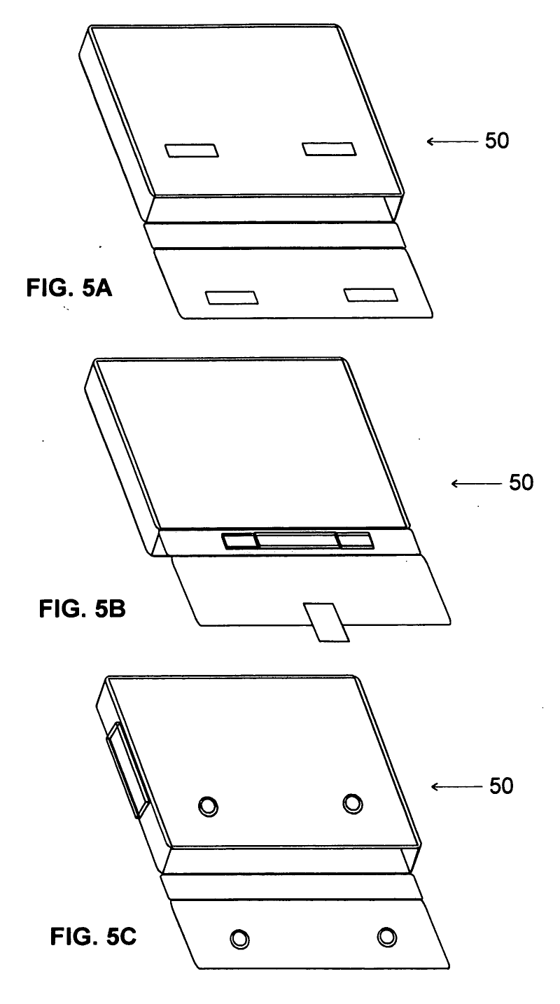

With reference to FIGS. 5A-5C, there are illustrated design variations of a protective bag 50 within which a tablet computer (i.e. a portable computer whose display panel screen faces outwardly, or away from, the body of the computer) can be placed for storage or transport. Each of the bag embodiments 50 employ a closable flap which is securable in a closed position with suitable closure means, such as hook-and-loop type fastener devices (e.g. Velcro), when a computer is positioned within the bag. Since the display panels of tablet computers commonly face away from the bodies of such computers, these computers could use the additional protection that a bag, such as the bag 50, can provide. Within the depicted bag 50, at least one or both of the two broadest sides of the bag 50 include embedded plastic or metal plates that are strong enough to withstand impacts which could otherwise damage a computer positioned therein.

It will be understood that numerous modifications and substitutions can be had to the aforedescribed embodiments without departing from the spirit of the invention. Accordingly, the aforedescribed embodiments are intended for the purpose of illustration and not as limitation.

1. In a computer having a relatively thin computer body and a relatively thin display panel, the improvement comprising:
an arm member having two opposite ends, one end of the arm member being attached to the computer body to permit pivotal movement of the arm member relative to the computer body, and the other end of the arm member being attached to the display panel to permit pivotal movement of the display panel relative to the arm member
so that by pivotally moving the arm member relative to the computer body and pivotally moving the display panel relative to the arm member, the display panel can be oriented in any of a number of positions relative to the computer body.

2. The improvement as defined in claim 1 wherein the arm member is permitted to pivot relative to the computer body about a first axis of pivot, the display panel is permitted to pivot relative to the arm member about a second axis of pivot, and the first and second axis of pivot are substantially parallel to one another.

3. The improvement as defined in claim 2 wherein each of the computer body has two opposite sides and the display panel has two opposite sides, each side of the display panel corresponds with a corresponding side of the computer body, one end of the arm member is attached to one side of the computer body, and the other end of the arm member is attached to the corresponding side of the display panel.

4. The improvement as defined in claim 2 wherein the computer body has two opposite sides and a rear edge which extends between the two opposite sides of the computer body, and said one end of the arm member is pivotally connected to the computer body for pivotal movement relative thereto along the rear edge thereof.

5. The improvement as defined in claim 4 wherein the display panel has a screen and a back on the side thereof opposite the screen, and said other end of the arm member is pivotally connected to the back of the display panel to permit pivotal movement of the display panel relative to said other end of the arm member.

6. The improvement as defined in claim 1 further including means associated with said other end of the arm member for permitting the display panel to be shifted along the length of the arm member to thereby permit an adjustment in position of the display panel toward and away from said one end of the arm member.

7. The improvement as defined in claim 6 wherein one of the display panel and the computer body includes means defining a guide track and the other of the display panel and the computer body includes means defining a guide track follower so that the display panel and the computer body cooperate as guide track and guide track follower as the display panel is slidably adjusted along the length of the arm member.

8. The improvement as defined in claim 7 further comprising means for releasably securing the display panel in a fixed position along the length of the arm member.

9. The improvement as defined in claim 2 wherein the arm member is a first arm member and the improvement further comprises a second arm member having two opposite ends, and one end of the second arm member is attached to the side of the computer opposite said one side of the computer body, and the other end of the second arm member is attached to the side of the display panel opposite said corresponding side of the display panel.

10. The improvement as defined in claim 2 wherein the display panel has a screen, and the display panel is pivotally connected to said other end of the arm member to accommodate a pivotal movement of the display panel relative to the arm member through at least about 180 degrees of rotation so that the screen of the display panel can be moved between a first condition at which the screen faces the computer body and a second condition at which the screen faces away from the computer body.

11. A computer comprising:
a relatively thin body;
a relatively thin display panel; and
an elongated arm member having two opposite ends, one end of the arm member being attached to the computer body to permit pivotal movement of the arm member relative to the computer body, and the other end of the arm member being attached to the display panel to permit pivotal movement of the display panel relative to the arm member
so that by pivotally moving the arm member relative to the computer body and pivotally moving the display panel relative to the arm member, the display panel can be oriented in any of a number of positions relative to the computer body.

12. The computer as defined in claim 10 wherein the arm member is adapted to pivot relative to the computer body about a first axis of pivot, the display panel is adapted to pivot relative to the arm member about a second axis of pivot, and the first and second axis of pivot are substantially parallel to one another.

13. The computer as defined in claim 12 wherein each of the computer body has two opposite sides and the display panel has two opposite sides, each side of the display panel corresponds with a corresponding side of the computer body, one end of the arm member is attached to one side of the computer body, and the other end of the arm member is attached to the corresponding side of the display panel.

14. The computer as defined in claim 12 wherein the computer body has two opposite sides and a rear edge which extends between the two opposite sides of the computer body, and said one end of the arm member is pivotally connected to the computer body for pivotal movement relative thereto along the rear edge thereof.

15. The computer as defined in claim 14 wherein the display panel has a screen and a back on the side thereof opposite the screen, and said other end of the arm member is pivotally connected to the back of the display panel to permit pivotal movement of the display panel relative to said other end of the arm member.

16. The computer as defined in claim 11 further including means associated with said other end of the arm member for permitting the display panel to be shifted along the length of the arm member to thereby permit an adjustment in position of the display panel toward and away from said one end of the arm member.

17. The computer as defined in claim 16 wherein one of the display panel and the computer body includes means defining a guide track and the other of the display panel and the computer body includes means defining a guide track follower so that the display panel and the computer body cooperate as guide track and guide track follower as the display panel is slidably adjusted along the length of the arm member.

18. The computer as defined in claim 17 further comprising means for releasably securing the display panel in a fixed position along the length of the arm member.

19. The computer as defined in claim 13 wherein the arm member is a first arm member and the computer further comprises a second arm member having two opposite ends, and one end of the second arm member is attached to the side of the computer opposite said one side of the computer body, and the other end of the second arm member is attached to the side of the display panel opposite said corresponding side of the display panel.

20. The computer as defined in claim 12 wherein the display panel has a screen and is pivotally connected to said other end of the arm member to accommodate a pivotal movement of the display panel relative to the arm member through at least about 180 degrees of rotation so that the display panel can be moved between a first condition at which the screen faces the computer body and a second condition at which the screen faces away from the computer body.
